(19) United States
(12) Patent Application Publication
(10) Pub. No.: US 2010/0184595 A1
(43) Pub. Date: Jul. 22, 2010

(54) TRANSITION METAL COMPLEX ANION-BASED HYDROGEN STORAGE MATERIAL SYSTEM

(75) Inventors: John J. Vajo, West Hills, CA (US); Wen Li, El Segundo, CA (US); Ping Liu, Irvine, CA (US); Tina T. Salguero, West Hills, CA (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/690,326

(22) Filed: Jan. 20, 2010

Related U.S. Application Data
(60) Provisional application No. 61/145,814, filed on Jan. 20, 2009.

(51) Int. Cl. B01J 20/04

(52) U.S. Cl. 502/406

(57) ABSTRACT

An exemplary embodiment and associated method of use discloses a hydrogen storage system that liberates hydrogen and includes a combination of at least one complex hydride containing a cation and a complex hydride anion based on boron, aluminum or nitrogen, together with an approximately stoichiometric or chemically equivalent amount of at least one other complex hydride containing a cation and a complex hydride anion based on a transition metal.

This application claims the benefit of U.S. Provisional Application No. 61/145,814 filed Jan. 20, 2009.

### TECHNICAL FIELD

The technical field generally relates to storage materials and more specifically to hydrogen storage in lithium systems.

### BACKGROUND

For widespread applications, reversible hydrogen storage materials are needed. It is highly desirable that these materials have high capacity, adjustable thermodynamics, and high rates of hydrogen exchange. Thermodynamic adjustment enables high hydrogen storage capacity materials with storage temperatures that are considered too high to be used at much lower temperatures while retaining high hydrogen storage capacities.

### SUMMARY OF EXEMPLARY EMBODIMENTS OF THE INVENTION

An exemplary embodiment and associated method of use discloses a hydrogen storage system including a combination of at least one complex hydride containing a cation and a complex hydride anion based on boron, aluminum or nitrogen, together with an approximately stoichiometric or chemically equivalent amount of at least one other complex hydride containing a cation and a complex hydride anion based on a transition metal.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a plot of an FTIR spectra graph that compares hydrogenated 4LiH+2MgB₂+Ni mixture, an LiBH₄ standard, and a Mg₂NiH₄ standard;

FIG. 2 is a graph comparing the amount of desorbed hydrogen versus time during a temperature ramp in an LiBH₄/Mg₂NiH₄ system;

FIG. 3 a graph comparing the amount of desorbed hydrogen into a hydrogen overpressure of about 4 bar versus time during a temperature ramp in an LiBH₄/Mg₂NiH₄ system versus an LiBH₄ standard and a Mg₂NiH₄ standard;

FIG. 4 is a graph comparing the amount of desorbed hydrogen versus temperature during the first step of dehydrogenation of milled 0.8LiBH₄+Mg₂NiH₄; and

FIG. 5 is a graph comparing the amount of desorbed hydrogen versus temperature for several samples of 0.8LiBH₄+Mg₂NiH₄ hydrogenated at various pressures.

### DETAILED DESCRIPTION OF EXEMPLARY EMBODIMENTS

The following description of the embodiment(s) is merely exemplary (illustrative) in nature and is in no way intended to limit the invention, its application, or uses.

One exemplary embodiment may include a hydrogen storage system including a combination of at least one first complex hydride containing a cation and a complex hydride anion based on boron, aluminum or nitrogen, together with an approximately stoichiometric or chemically equivalent amount of at least one second complex hydride containing a cation and a complex hydride anion based on a transition metal. The combination can be achieved by an appropriate milling or mixing of the individual components.

The hydrogen storage system of the exemplary embodiments may find use in virtually any application connected with hydrogen storage.

One non-limiting application for the hydrogen storage system includes military applications such as hydrogen storage systems for stationary and mobile power sources, remote power and low signature power.

Another non-limiting application for the hydrogen storage system includes aerospace applications such as a hydrogen storage system for auxiliary fuel cell power.

Still another non-limiting application for the hydrogen storage system includes automotive applications such as hydrogen storage systems for fuel cells and combustion engines.

Other non-limiting applications for the hydrogen storage system includes commercial applications such as hydrogen storage systems for stationary fuel cells for distributed power and consumer applications such as hydrogen storage systems for fuel cell powered portable electronic devices.

Because of the chemical interactions between the cation, the complex hydride anion (i.e. either boron, aluminum or nitrogen) of the first complex hydride, the cation and the second complex hydride anion (i.e. the transition metal), alloy or compound formation can occur during dehydrogenation and thus the overall thermodynamics of the combined system will be altered from the thermodynamics of the first or second complex hydrides separately. In addition, because of the possible stoichiometries of the alloys that can form during dehydrogenation, high hydrogen capacity may be possible. Furthermore, because the transition metal atom of the transition metal-based complex hydride anions often functions catalytically, the kinetics of the dehydrogenation reaction may be superior to thermodynamically adjusted systems that do not contain transition metal-based complex hydride anions.

One specific embodiment, which will be described in detail below, is the LiBH₄/Mg₂NiH₄ system. This system contains 4 moles of LiBH₄ combined with 1 mole of Mg₂NiH₄. In this example, LiBH₄ is a complex hydride containing the complex hydride anion [BH₄]⁻, which is based on boron, and Mg₂NiH₄ is a complex hydride containing the complex hydride anion [NiH₄]⁴⁻, which is based on the transition metal Ni. Because of the chemical interactions between B from the LiBH₄ and the Mg and/or Ni from the Mg₂NiH₄, alloy formation occurs during dehydrogenation and thus the overall thermodynamics of the combined system is altered from the thermodynamics of LiBH₄ and Mg₂NiH₄ separately. Moreover, as shown below, the dehydrogenation reaction between LiBH₄ and Mg₂NiH₄ occurs at a temperature that is lower than the temperature for dehydrogenation of either LiBH₄ or Mg₂NiH₄ separately.

The overall dehydrogenation reaction for the LiBH₄/Mg₂NiH₄ system including the theoretical hydrogen capacity in weight percent can be expressed as:

4LiBH₄+Mg₂NiH₄→1/7.5Mg₃Ni_{7.5}B₆+4LiH+1.6MgB₂+8H₂ (8.0 weight percent) or 1

4LiBH₄+Mg₂NiH₄→⅕Li_{2.4}Ni₅B₄+3.52LiH+1.6MgB₂+0.4Mg+8.24H₂ (8.3 weight percent) 2

With a larger stoichiometric ratio of LiBH₄ to Mg₂NiH₄ of 4.8:1 (versus 4:1 in Reactions 1 and 2) the following reaction could occur:

24LiBH₄+5Mg₂NiH₄→Li_{2.4}Ni₅B₄+21.6LiH+10MgB₂+47.2H₂ (8.7 weight percent) 3

Other specific exemplary embodiments that utilize LiBH₄ as the complex hydride and include different complex hydrides containing transition metal-based complex hydride anions (i.e. other than Mg₂NiH₄) are illustrated in Reactions 4-9 below:

5LiBH₄+Mg₂FeH₆→5LiH+2MgB₂+FeB+10.5H₂ (9.5 weight percent) 4

5LiBH₄+Mg₂CoH₅→5LiH+2MgB₂+CoB+10H₂ (9.0 weight percent) 5

13LiBH₄+Ca₂FeH₆→13LiH+2CaB₆+FeB+22.5H₂ (10.5 weight percent) 6

13LiBH₄+Sr₂FeH₆→13LiH+2SrB₆+FeB+22.5H₂ (8.5 weight percent) 7

14LiBH₄+Ca₂RuH₆→14LiH+2CaB₆+RuB₂+24H₂ (9.6 weight percent) 8

LiBH₄+Li₃RhH₆→4LiH+RhB+3H₂ (3.9 weight percent) 9

Other complex hydrides containing transition metal-based complex hydride anions [IEA/DOE/SNL Hydride Databases available at Hydride Information Center, Sandia National Laboratories Home Page, http:/hydpark.ca.sandia.gov/; K. Yvon, In Encyclopedia of Inorganic Chemistry, R B King, Ed. Wiley (1994)] that could be used in this invention are BaMg₂RuH₈, Ca₂RhH₄, CaPdH₂, K₃PdH₃, Li₄RuH₆, Mg₂IrH₅, Mg₂RuH₆, Mg₂RuH₄, CaIrH₅, Li₃IrH₆, LiMg₂RuH₇, SrMg₂FeH₈, KMnH₆, Mg₃MnH₇ or KZnH₄.

Specific exemplary complex hydride anions based on transition group metals that could be used include: [MnH₄]²⁻, [MnH₆]⁵⁻, [FeH₆]⁴⁻, [FeH₈]⁶⁻, [CoH₅]⁴⁻, [NiH₄]⁴⁻, [TcH₉]²⁻, [RuH₆]⁴⁻, [RuH₄]⁴⁻, [RuH₃]⁶⁻, [RuH₇]³⁻, [RhH₄]³⁻, [RhH₆]³⁻, [PdH₂]²⁻, [PdH₃]³⁻, [PdH₄]²⁻, [PdH₄]⁴⁻, [ReH₉]²⁻, [ReH₆]⁵⁻, [OsH₆]⁴⁻, [OsH₇]³⁻, [IrH₅]⁴⁻, [IrH₆]³⁻, [PtH₄]²⁻, [PtH₂]²⁻, [PtH₆]²⁻, or [ZnH₄]²⁻. Based on formal valances, these complex hydride anions contain transition metals in the following valance states: Ni(0), Pd(0), Co(1+), Rh(1+,3+), Ir(1+,3+), Fe(2+), Ru(0,2+), Pt(2+,4+), Os(2+,4+), and Re(1+,7+).

In addition to the specific hydrides listed above, in other exemplary embodiments, the system may contain further catalytic additives at substoichiometric levels of about 0.01 to 10 mole percent. Examples of additives include TiCl₃, TiF₃, TiH₂, TiO₂, cyclopentadienyl.TiCl₃, VCl₃, CrCl₃, MnCl₂, NbCl₅, LaCl₃, TaCl₅, Ni, and NiCl₂.

### Example 1

### The LiBH₄/Mg₂NiH₄ System Beginning with Elemental Nickel

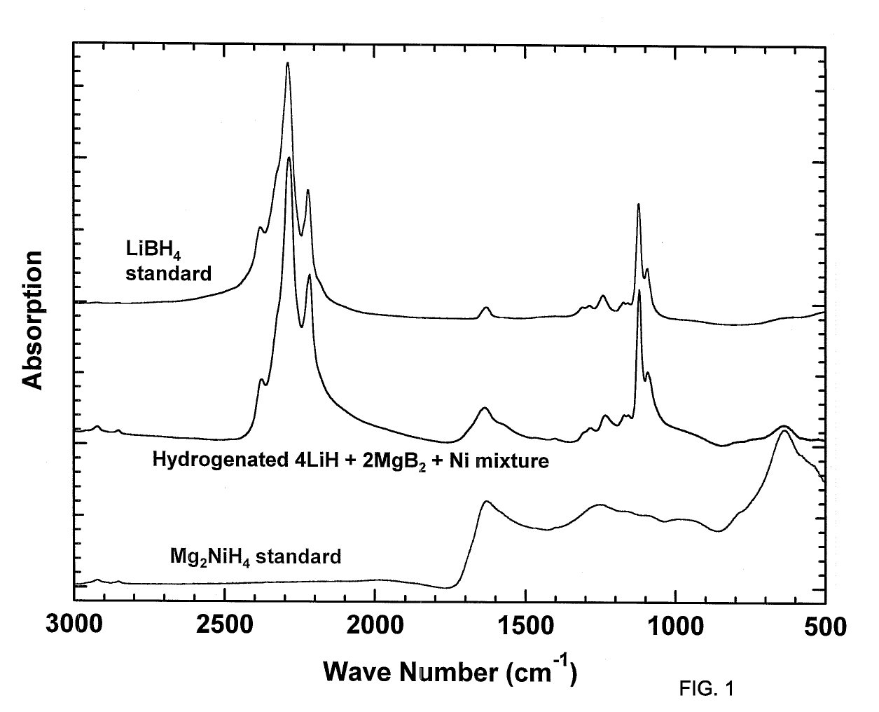

To form the LiBH₄/Mg₂NiH₄ system which contains 4 moles of LiBH₄ combined with 1 mole of Mg₂NiH₄ where LiBH₄ is a complex hydride containing the complex hydride anion [BH₄], which is based on boron, and Mg₂NiH₄ is a complex hydride containing the complex hydride anion [NiH₄]⁴⁻, which is based on the transition metal Ni, we began with a mixture of 4LiH+2MgB₂+Ni. Powdered LiH with a purity of about 97% was obtained from Fluka. Magnesium diboride (MgB₂) was obtained from Aldrich. Nanoscale Ni powder with a particle size of about 50 nanometers was obtained from Argonide. A mixture of about 0.211 grams LiH, about 0.606 grams MgB₂, and about 0.382 grams Ni was mechanically milled in an 80 cm³ hardened-steel milling vessel with thirty Cr-steel milling balls 7 mm in diameter using a Frisch P6 planetary mill operated at 400 rpm for about 1 hour. All material handling was performed in an argon filled glove box with, less than 1 ppm oxygen and water concentrations. After milling the mixture was hydrogenated in a volumetric gas apparatus. This apparatus is described in detail in J. J. Vajo, F. Mertens, C. C. Ahn, R. C. Bowman, Jr., B. Fultz, J. Phys. Chem. B 108, 13977-13983 (2004). The hydrogenation treatment consisted of exposing the mixture to about 100 bars of hydrogen gas, heating at about 2 degrees Celsius/min to about 350 degrees Celsius, holding the temperature constant for about 4 hours, and slowly cooling to room temperature. After this treatment, FTIR spectroscopy was used to characterize the mixture. As shown in FIG. 1, the mixture consisted of LiBH₄ and Mg₂NiH₄.

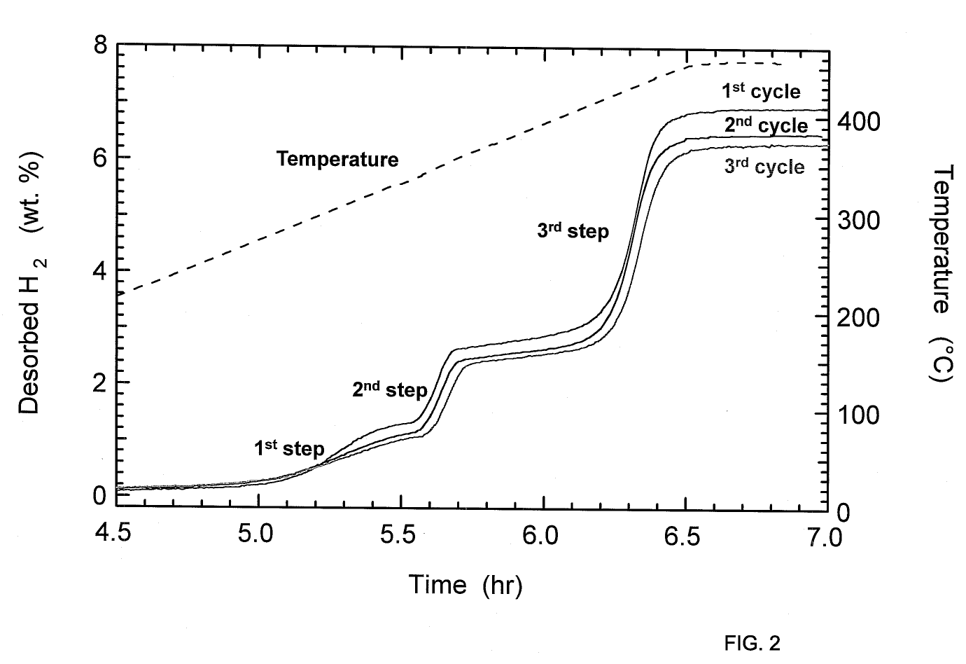

After hydrogenation, the dehydrogenation behavior was examined using the same volumetric gas apparatus. FIG. 2 shows the amount of desorbed hydrogen in weight percent as a function of time during heating to about 450 degrees Celsius at a constant rate of about 2 degrees Celsius/minute and then holding the temperature constant in an overpressure of about 4 bars of hydrogen. Desorption of hydrogen occurs in 3 reaction steps. The first step occurs with a midpoint temperature of 300 degrees Celsius and releases approximately 1.4 weight percent hydrogen. The second step occurs with a midpoint temperature of about 350 degrees Celsius and releases approximately 1.4 weight percent hydrogen. After the second step a total of approximately 2.8 weight percent hydrogen was released. The third step releases about 4.2 wt % hydrogen with a midpoint temperature of 420 degrees Celsius. The total amount of hydrogen released for the three steps is thus approximately 7 weight percent. Based on the amount of hydrogen released in each step, these steps may be expressed in Reactions 10-12 as:

4LiBH₄+Mg₂NiH₄→1/7.5Mg₃Ni_{7.5}B₆+0.8LiH+1.6MgH₂+3.2LiBH₄+1.6H₂ (1.6 weight percent) 10

1.6MgH₂→1.6Mg+1.6H₂ (1.6 weight percent) 11

3.2LiBH₄+1.6Mg→3.2LiH+1.6MgB₂+4.8H₂ (4.8 weight percent) 12

for steps 1, 2, and 3, respectively. Overall, Reactions 10-12 sum to Reaction 1.

FIG. 2 also shows that the combined LiBH₄/Mg₂NiH₄ material system can store hydrogen reversibility. After dehydrogenation, the system was rehydrogenated by exposure to about 100 bars of hydrogen at about 350 degrees Celsius for about 4 hours. After a 2^{nd} dehydrogenation, an identical 2^{nd} rehydrogenation was performed followed by a 3^{rd} dehydrogenation. The 2^{nd} and 3^{rd} dehydrogenation cycles, shown in FIG. 2, demonstrate that the system may be reversible. Although the system may be reversible, there is a decrease in the amount of hydrogen released in the 1^{st} step from the 1^{st} to the 2^{nd} cycle.

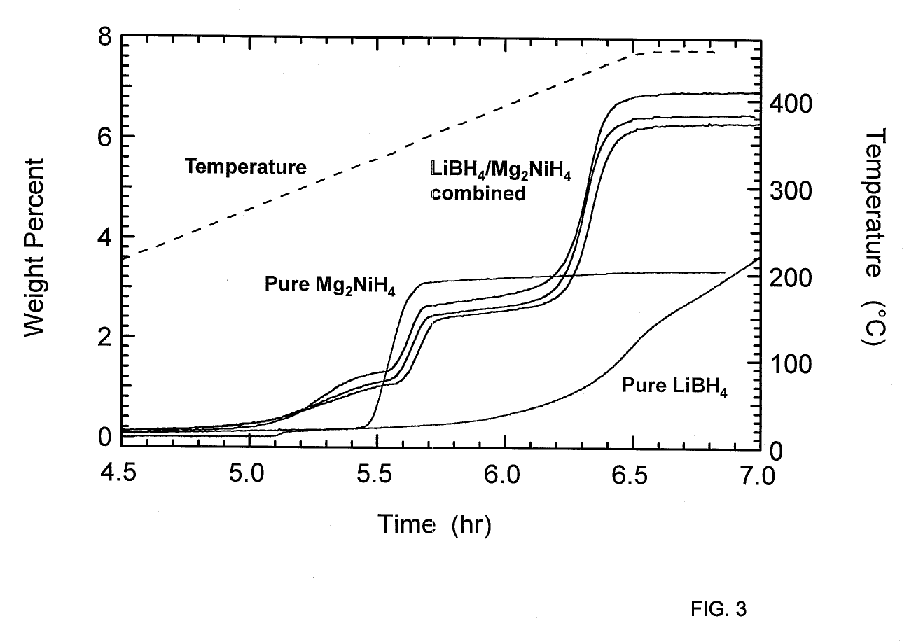

FIG. 3 compares the dehydrogenation behavior of the LiBH₄/Mg₂NiH₄ combination into a hydrogen overpressure of about 4 bar to the behavior of LiBH₄ and Mg₂NiH₄ separately. As shown in FIG. 1, the LiBH₄/Mg₂NiH₄ combination dehydrogenates in three steps with the first step having a midpoint temperature of about 300 degrees Celsius. In contrast, LiBH₄ separately does not dehydrogenate appreciably until above about 400 degrees Celsius. Similarly, Mg₂NiH₄ separately does not dehydrogenate until about 350 degrees Celsius. This comparison illustrates that first dehydrogenation reaction step of LiBH₄ with Mg₂NiH₄ occurs in a concerted fashion at a temperature lower than the dehydrogenation reaction of LiBH₄ or Mg₂NiH₄ separately.

### Example 2

### The LiBH₄/Mg₂NiH₄ System Beginning with LiBH₄ and Mg₂NiH₄

Lithium borohydride (LiBH₄) with a purity of about 95% was obtained from Aldrich. Magnesium nickel hydride (Mg₂NiH₄) was prepared by direct hydrogenation using about 100 bars of hydrogen at about 360 degrees Celsius for about 4 hours of Mg₂Ni alloy obtained from Ergenics Inc. (HY-Stor 301). The purity of the hydride after hydrogenation was verified by x-ray powder diffraction, which indicated that there was no residual Mg₂Ni alloy. Based on the net stoichiometry of Reaction 10, a combination of about 0.8 moles of LiBH₄ and about 1 mole of Mg₂NiH₄ was prepared by mechanically milling about 0.166 grams of LiBH₄ and about 1.034 grams of Mg₂NiH₄ in an 80 cm³ hardened-steel milling vessel with 30.7 mm diameter Cr-steel milling balls using a Frisch P6 planetary mill operated at about 400 rpm for about 1 hour.

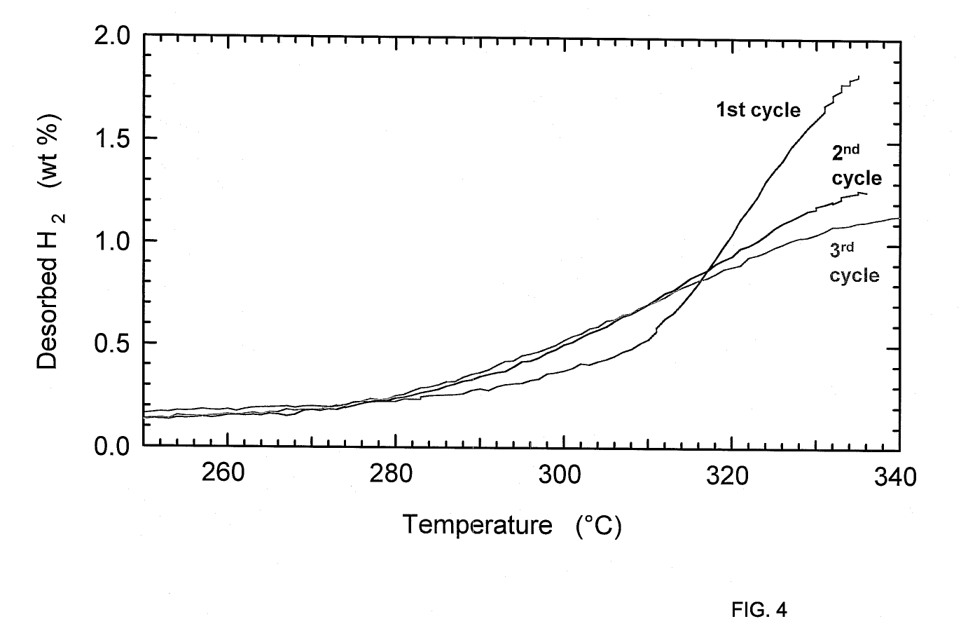

After milling, the dehydrogenation behavior was examined using the same volumetric gas apparatus. FIG. 4 shows the amount of desorbed hydrogen in the 1^{st} reaction step during heating at a constant rate of about 2 degrees Celsius/minute in an overpressure of about 4 bars of hydrogen. The behavior is nearly identical to the 1^{st} step shown in FIG. 1. The similarity demonstrates that the LiBH₄/Mg₂NiH₄ material system can be prepared by directly combining the first and second hydrides or by hydrogenation of suitable precursors (as shown In Example 1). After the initial dehydrogenation, 2^{nd} cycle and 3^{rd} cycle dehydrogenations were performed after hydrogenation in about 100 bars of hydrogen at about 360 degrees Celsius for about 4 hours. As shown in FIG. 4 the amount of desorbed hydrogen decreased from the 1^{st} to 2^{nd} cycle but was then nearly constant for the 3rd cycle. This behavior again demonstrates that the combined system may be reversible. The reaction dehydrogenation reaction may be written as:

0.8LiBH₄+Mg₂NiH₄→1/7.5Mg₃Ni_{7.5}B₆+0.8LiH+1.6MgH₂+1.6H₂ (1.6 weight percent) this is identical to Reaction 10 except that there is no excess of LiBH4. 13

### Example 3

### Equilibrium Pressure for the LiBH₄/Mg₂NiH₄ 1^{st} Reaction Step

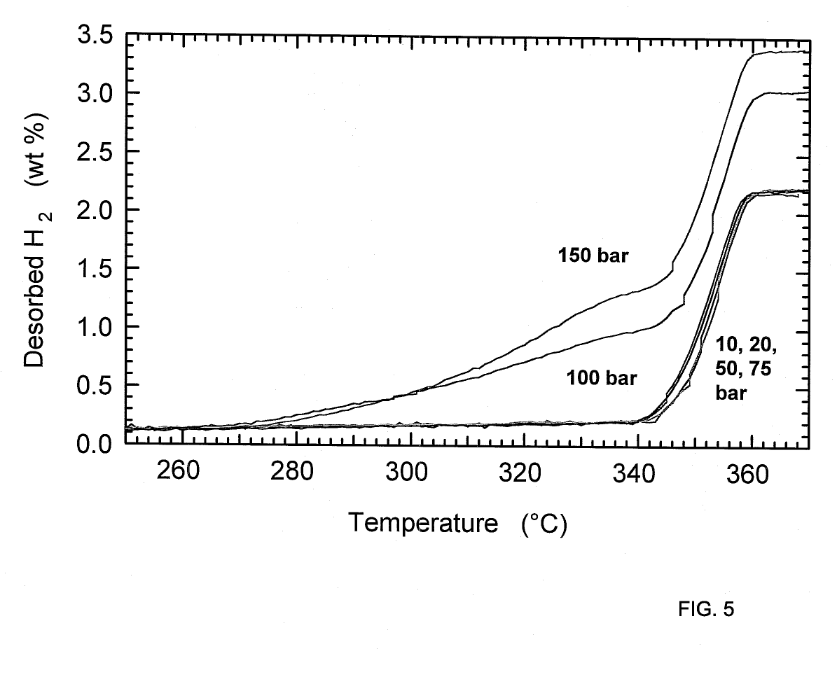

The dehydrogenation and rehydrogenation thermodynamics of the first step, given by Reaction 13, are also adjusted from the thermodynamics of LiBH₄ or Mg₂NiH₄ separately. This adjustment may be shown by the dehydrogenation cycles shown in FIG. 5. Using the mixture prepared in Example 2, dehydrogenation cycles were performed after prolonged hydrogenation at about 310 degrees Celsius with hydrogen gas pressures of about 10, 20, 50, 75, 100, and 150 bars. After exposure to hydrogen at about 10, 20, 50, or 75 bars, no dehydrogenation is observed. In contrast, full dehydrogenation is observed after hydrogenation at about 100 and about 150 bars. These results indicate that at about 310 degrees Celsius, the equilibrium hydrogen pressure for Reaction 13 is greater than about 75 bars and less than about 100 bars. This equilibrium pressure may be considerably higher than the equilibrium hydrogen pressure for either pure LiBH₄ or pure Mg₂NiH₄ The equilibrium pressure for pure LiBH₄ has been difficult to measure but is believed to be about 1 bar at about 400 degrees Celsius. [A. Züttel, S. Rentsch, P. Fischer, P. Wenger, P. Sudan, Ph. Mariner, Ch, Emmenegger, J. Alloys Comp. 356-357 (2003) 515-520] Because the equilibrium pressure decreases exponentially with decreasing temperature, the pressure at about 310 degrees Celsius may be much less than 1 bar. The equilibrium pressure for pure Mg₂NiH₄ has been well characterized and is about 1.5 bars at about 310 degrees Celsius. [IEA/DOE/SNL Hydride Databases available at Hydride Information Canter, Sandia National Laboratories Home Page, http:/hydpark.ca.sandia.gov/l The large increase in equilibrium hydrogen pressure for the combination of 0.8LiBH₄+Mg₂NiH₄ (Reaction 13) relative to either component separately, indicates a large thermodynamic adjustment, in this case a large destabilization, in the combined system.

The above description of embodiments of the invention is merely exemplary in nature and, thus, variations thereof are not to be regarded as a departure from the spirit and scope of the invention.

What is claimed is:

1. A hydrogen storage system comprising:
a first complex hydride containing a cation and a complex hydride anion based on boron, aluminum, or nitrogen; and
a second complex hydride containing a cation and a complex hydride anion based on a transition metal.

2. The hydrogen storage system of claim 1, wherein said complex hydride anion based on boron, aluminum, or nitrogen comprises [BH₄]⁻, [AlH4]⁻, [AlH₆]³⁻, or [NH₂]⁻.

3. The hydrogen storage system of claim 1, wherein said complex hydride anion based on a transition metal comprises [MnH₄]²⁻, [MnH₆]⁵⁻, [FeH₆]₄₋, [FeH₈]⁶⁻, [CoH₅]⁴⁻, [NiH₄]⁴⁻, [TcH₉]²⁻, [RuH₆]⁴⁻, [RuH₄]⁴⁻, [RuH₃]⁶⁻, [RuH₇]³⁻, [RhH₄]³⁻, [RhH₆]³⁻, [PdH₂]²⁻, [PdH₃]³⁻, [PdH₄]²⁻, [PdH₄]⁴⁻, [ReH₉]²⁻, [ReH₆]⁵⁻, [OsH₆]⁴⁻, [OsH₇]³⁻, [IrH₅]⁴⁻, [IrH₆]³⁻, [PtH₄]²⁻, [PtH₂]²⁻, [PtH₆]²⁻, or [ZnH₄]²⁻.

4. The hydrogen storage system of claim 1, wherein said first complex hydride comprises LiBH₄.

5. The hydrogen storage system of claim 1, wherein said second complex hydride based on a transition metal comprises Mg₂NiH₄, Mg₂FeH₄, Mg₂CoH₅, Ca₂FeH₆, Sr₂FeH₆, Ca₂RuK₄, Li₃RhH₆, BaMg₂RuH₈, Ca₂RhH₄, CaPdH₂, K₃PdH₃, Li₄RuH₆, Mg₂IrH₅, Mg₂RuH₆, Mg₂RuH₄, CaIrH₅, Li₃IrH₆, LiMg₂RuH₇, SrMg₂FeH₈, KMnH₆, Mg₃MnH₇ or KZnH₄.
